(19) United States
(12) Patent Application Publication
(10) Pub. No.: US 2026/0233043 A1
(43) Pub. Date: Aug. 13, 2026

(54) THERMO ACTIVATOR WITH BUILT-IN POWER SOURCE

(71) Applicants: Mustafa Bilal POLAT, Atasehir, Istanbul (TR); Hakan ÖZKAYNAK, Atasehir, Istanbul (TR)

(72) Inventor: Mustafa Bilal POLAT, Atasehir, Istanbul (TR)

(21) Appl. No.: 19/156,038

(22) PCT Filed: Feb. 14, 2023
(86) PCT No.: PCT/TR2023/050142

§ 371 Date: Aug. 13, 2025

(51) Int. Cl. A62C 37/14

(52) U.S. Cl. CPC A62C 37/14

(57) ABSTRACT

A thermo activator that enables any unit, equipment, mechanism, fuse, module, device etc. and/or systems to which it is connected to be operated, shut down, controlled, regulated, activated and/or de-activated as desired (stand alone, single, multiple) autonomously and automatically or dependently when the ambient temperature reaches a desired (predetermined) level.

### TECHNICAL FIELD

This invention relates to a thermo activator that enables any unit, equipment, mechanism, fuse, module, device etc. and/or systems to which it is connected to be operated, shut down, controlled, regulated, activated and/or de-activated as desired (stand alone, single, multiple) autonomously and automatically or dependently when the ambient temperature reaches a desired (predetermined) level.

### PRIOR ART

Activators are used in many different areas recently. One of the common uses today is fire extinguishing systems.

Although there are different fire extinguishing systems such as water mist, foam and powder systems, more commonly used fire extinguishing systems are as follows;
Water Fire Extinguishing (Sprinkler) Systems: They work with the principle of water flowing from the sprinkler with the bursting of the glass tube at the end point and extinguishes the fire. With the bursting of the glass tube, no power source is activated; therefore, no signal is transmitted from the power supply.
Gas Fire Extinguishing Systems: They work with the principle of discharging the gas in a pressurized container at the time of fire and extinguishing the fire. They are usually used manually. They require regular maintenance, some of them extinguish fire through oxygen displacement (reduction of oxygen content). They do not have a power source that they engage when they operate.
Aerosol Fire Extinguishing Systems: Compared to alternative systems, they have become widespread recently because they are more economical. They are environmentally friendly, non-toxic, do not damage the ozone layer. They work with the principle of generating a cloud (aerosol) as a result of activation of a solid chemical compound (mostly Potassium Carbonate based) in a non-pressurized container (Aerosol Generator) in various ways and extinguishing the fire. Presently, the websites of the leading companies working on this subject are; https://www.statx.com and https://www.firepro.com.

In the present state of the technique, the Solid Compounds in the Aerosol Generators are activated by the following methods:
A. THERMAL ACTIVATION: In outline, it can be done in two ways:
A.1. With a wick: A wick attached to the Aerosol Generator catches fire in the event of a fire, the burning wick carries the flame to the solid compound and activates it.

### The Problems/Disadvantages of the Wick Solution are as Follows;

Most wicks lose their properties over time, their efficiency decreases.
Most wicks are negatively affected by humid environments.
Only one generator can be activated with one wick.
They are not suitable for grouping.
They are suitable for stand-alone solutions and can be used in spaces small enough to be extinguished by a single generator.
Wick activation cannot be used in places where more than one generator should be used at the same time to extinguish a fire.
They comply with the logic of one generator in one space. Since fire in large spaces cannot be extinguished with a single generator, wick activation cannot be used in large spaces, it can only be used in small spaces (e.g. electrical panels).
They are not suitable for use in large capacity generators, they are generally used in low/small capacity generators.
Wicks cannot interact with any internal or external signals. They cannot produce, receive or transmit any signal. For this reason, they cannot be integrated with any weak or strong current system (fire alarm, fire extinguishing, ventilation, heating, cooling, automation, communication, sound, warning, etc. system) and/or unit, equipment, mechanism, fuse, module, device etc. other than the point (unit/generator) to which they are connected, and they cannot work in conjunction with them. In summary, any unit, equipment, mechanism, fuse, module or device etc. activated by a wick cannot be part of an engineering system. For example, an aerosol generator activated by a wick cannot be considered part of an engineered fire extinguishing system.
They cannot send a signal to anywhere about a fire that breaks out in their location. In this sense, they cannot work like a detector.

A.2 With Thermal Activator: A thermal activator (thermal head) connected to the generator reacts when the ambient temperature reaches a certain level, and activates the solid compound inside the generator. Thermal heads from StatX, one of the major manufacturers on the market, are manufactured to operate at only 3 different temperatures (70° C., 95° C., or 123° C.). Related con figurations can be accessed from the web page https://www.statx.com/product/stat-x-fire-suppression-system-thermal-units

The thermal activators of Fire Pro, the other major manufacturer on the market, are manufactured to operate at 6 different temperature levels (57° C., 68° C., 79° C., 93° C., 141° C., 182° C.). The relevant configurations are available on the web page https://www.firepro.com/en/products.

The main difference between Fire Pro's BTA V3 thermal activator and the activator, which is the subject of this disclosure is that the thermo activator of this invention has a built-in internal power source, and when the predetermined temperature level is reached, it can receive energy from the internal power source and regulate one or more points or systems as desired with this electrical signal. In other words, everything that can be regulated by an electrical signal can be regulated by the thermo-activator, which is the subject of this invention. The thermal activator of Fire Pro company does not have a built in power source and activates only one single generator to which it is connected. Moreover, the said activator is not suitable for integration and cannot be used within a group and/or system.

### The Problems/Disadvantages of the Thermal Activator Solution are as Follows;

In the present technique, only one single unit (generator) can be activated with a Thermal Activator.
They are not suitable for grouping.
They are suitable for stand-alone solutions and can be used in spaces small enough to be extinguished by a single generator.
Thermal activators cannot be used in places where more than one generator should be used at the same time to extinguish a fire.
They comply with the logic of one generator in one space. Since fire in large spaces cannot be extinguished with a single generator, thermal activators cannot be used in large spaces, they can only be used in small spaces (e.g. electrical panels).
Thermal activators cannot interact with any internal or external signal. They cannot produce, receive or transmit any signal. For this reason, they cannot be integrated with any weak or strong current system (fire alarm, fire extinguishing, ventilation, heating, cooling, automation, communication, sound, warning, etc. system) and/or unit, equipment, mechanism, fuse, module, device etc other than the point (unit/generator) to which they are connected, and they cannot work in conjunction with them.
They cannot send a signal to anywhere about a fire that breaks out in their location. In this sense, they cannot work like a detector.
In models that use glass bulb as a heat-sensitive component, the glass bulbs are not protected against external influences.

B. ELECTRICAL ACTIVATION: It is based on the principle of activation by an electrical signal from an external source (e.g. alarm/control panel).

The products that perform activation in the said way are available on the website of StatX https://www.statx.com/product/stat-x-fixed-system-electrical-units.

In order to perform electrical activation, an engineering system must be installed in the place where the activator will be used. For example, if electrical activation is to be used for fire extinguishing purposes, a pre-engineered fire detection and extinguishing system must be installed in the place where the extinguishing will be carried out. This system mainly works with the principle of transmitting the fire signal received from the heat, smoke or flame detectors in the place to be extinguished to a fire panel, and remotely activating the extinguishing equipment connected to the fire extinguishing system with the electrical signal coming from this panel.

### The Problems/Disadvantages of Electrical Activation in the Present Technique are as Follows;

Electrically activated extinguishing equipment do not have the possibility of autonomous/independent operation (like in thermal activation), in any case they are dependent on external signal.
If there is no external electrical signal, electrical activation cannot be performed.
Electrical activators do not have any built-in power source. In any case, they need an external power supply.
Electrical activation cannot be performed in the event that electricity does not come from the external power source for any reason (for example, in the event of a disaster (earthquake, fire, flood, etc.), the detectors may not function, the cables between detectors and the control panel may be damaged, the power supply cables coming to the control panel may be damaged, the cables from the control panel to the extinguishing equipment may be damaged).
The unit, equipment, mechanism or assembly to be activated electrically, must be part of a system. If there is no pre-engineered system in the place, electrical activation cannot be used.
For example, if electrical activation is to be used for fire extinguishing purposes, it is essential that there is a fire detection system (consisting of heat, smoke or flame detectors, etc) in the place where the electrical activation will be carried out. There must be a fire panel (usually outside, sometimes far away from the place where the extinguishing will be carried out), a power (electricity) source in this panel, cables from the power source in the panel to the extinguishing equipment (generators).
The cost of electrical activation is higher, as system installation is essential (detectors, cables, alarm panels, external power supply, assembly, testing, commissioning and periodic maintenance).
Since it is costlier, it is not feasible to use electrical activation in small spaces (for example, in an electrical panel). It may only make sense to use electrical activation for extinguishing purposes in large spaces (by remotely activating multiple generators at the same time).
Aerosol Generators on their own do not require maintenance for about 10-15 years. Therefore, they have advantages over alternative extinguishing variants (especially pressurized systems). When these generators are desired to be activated electrically, both the initial investment and periodic maintenance costs of the system to be installed increases substantially. The electrical activation solution therefore reduces the competitiveness (initial investment and service costs) of aerosol extinguishing systems.

C. THERMO ELECTRICAL ACTIVATION: It is based on the principle that a thermally triggered activator performs activation with the electrical energy it receives from its internal power source. In the present technique there is an activator that works on this principle, which is sold by company DSPA. The product of the said company is accessed from the web page https://dspa.nl/products/standalone-solutions. The said activator can also be accessed from the web page of Granit Salamandra company https://en.granit-salamandra.ru/production/associated/sensors/tpe

### The Problems/Disadvantages of Thermo Electrical Activators in the Present Technique are as Follows;

They only offer stand-alone solutions.
They are only suitable for use in small areas, they cannot be used in large areas.
They cannot activate more than two units at the same time.
They cannot be controlled by an external signal.
They work only autonomously and automatically, they cannot be used dependently.
They cannot be integrated with an engineering system, they cannot be part of an engineering system.
They cannot be installed directly on the unit, equipment, mechanism or assembly they will activate, they require intermediate (auxiliary) elements.
The distance between the unit they will activate and the activator must be less than 3 meters.
As a heat-sensitive part, they use the entire sprinkler head used in the water fire extinguishing system.
The glass bulbs inside the sprinkler head are vulnerable to external impacts (effects).
There is no safety pin on them.

D. MANUAL ACTIVATION; It is based on the principle of activating the generator by manually pulling the pin on the activator.

StatX's manual activators are available on the web page https://www.statx.com/product/stat-x-fixed-system-manual-units.

Fire Pro's Aerosol Generator with manual activator is available on the web page https://www.firepro.com/en/products/HERO-generators.

### The Problems/Disadvantages of Manual Activation in the Present Technique are as Follows;

Human intervention is essential for their operation, the activation pin on the activator must be pulled manually.
The person who will perform the manual activation must have prior training on the subject. This person needs to know what to do in the event of a fire, to start the aerosol generator by pulling the pin by hand without panicking.
There is no guarantee that there will be someone in the place where/when the fire breaks out,
Even if there is someone in the place where/when a fire occurs, it is very unlikely that the person is experienced/trained in fire intervention.
Manual activation by an untrained/inexperienced person can even cause life threatening hazards for other people located in the space.
Due to its technology (it creates a mist like cloud in the space, reduces visibility to zero), aerosol extinguishing cannot be used in places where there are many people. Aerosol extinguishing is mostly preferred in places where there are no or very few people (technical areas, warehouses, data centers, panels, electrical rooms, machine rooms, etc.). In such places, it is very unlikely that there will be a person who can perform manual activation in the event of a fire.
For the above reasons, it is very unlikely that a fire can be extinguished by manually activating an aerosol generator.
Only one unit (generator) can be activated by a Manual Activator, and if more than one generator is to be activated at the same time, a separate pulling device must be installed (see StatX's dual assembly). Even with such a setup, multiple activations are impossible.
They are not suitable for grouping.
Manual activation cannot be used in places where more than one/two generators need to be used together at the same time to extinguish the fire.
Manual activation cannot be used in large places as a large number of generators must be activated at the same time to extinguish the fire in large spaces.
There is no internal or external signal in manual activation. Neither a signal is received, nor transmitted. For this reason, manual activators cannot be integrated with any weak or strong current system (fire alarm, fire extinguishing, ventilation, heating, cooling, automation, communication, sound, etc. system) and/or unit, equipment, mechanism, fuse, module, device etc other than the point (unit/generator) to which they are connected. In summary, any unit, equipment, mechanism or assembly with a manual activator cannot be part of an engineering system.

In the patent application document number TR2022/013963, which is found in the known state of the technique, an activator is described which is used as a trigger in fire extinguishing systems and which enables the fire extinguishing system to be triggered by generating electrical energy when the temperature in the environment reaches the predetermined temperature. However, the said application document does not mention a thermo activator that enables any unit, equipment, mechanism, fuse, module, device etc and/or systems to which it is connected to be operated, shut down, controlled, regulated, activated and/or de-activated as desired (stand alone, single, multiple) autonomously and automatically or dependently when the surrounding temperature reaches a desired (predetermined) level.

### Purpose of the Invention

The invention is inspired by the current situation and aims to solve the problems mentioned above.

The purpose of this invention is to provide a thermo activator that enables any unit, equipment, mechanism, fuse, module, device etc and/or systems to which it is connected to be operated, shut down, controlled, regulated, activated and/or de-activated as desired (stand alone, single, multiple) autonomously and automatically or dependently when the surrounding temperature reaches a desired (predetermined) level.

The structural and characteristic features and all the advantages of the invention will be understood more clearly by means of the detailed description written by referring to the figures given below and therefore the evaluation should be made by considering these figures and the detailed description.

### FIGURES TO HELP UNDERSTANDING OF THE INVENTION

FIG. 1 is a perspective view of the thermo activator, which is the subject of the invention, connected to a sample signal point.

FIG. 2 is a side view of the thermo activator, which is the subject of the invention, connected to a sample signal point.

FIG. 3 is a cross-sectional view of the thermo activator, which is the subject of the invention, connected to a sample signal point.

Description of Part References

| | |
|---|---|
| 1. | Thermo activator |
| 2. | Heat-sensitive part |
| 3. | Cap |
| 4. | Built-in power source |
| 5. | Power source slot |
| 6. | Contact part |
| 7. | Body |
| 8. | Spring |
| 9. | Signal cable |
| 10. | Cable slot |
| 11. | Secondary pin |
| 12. | Safety pin |
| 13. | Installation pin |
| 14. | Signal transmission mechanism |
| 15. | Cable lug |
| 16. | Set screw |
| 17. | Chip |
| A. | Signal point |

### DETAILED DESCRIPTION OF THE INVENTION

In this detailed explanation, the preferred configurations of the activator (1), which is the subject of the invention, are explained only for a better understanding of the subject.

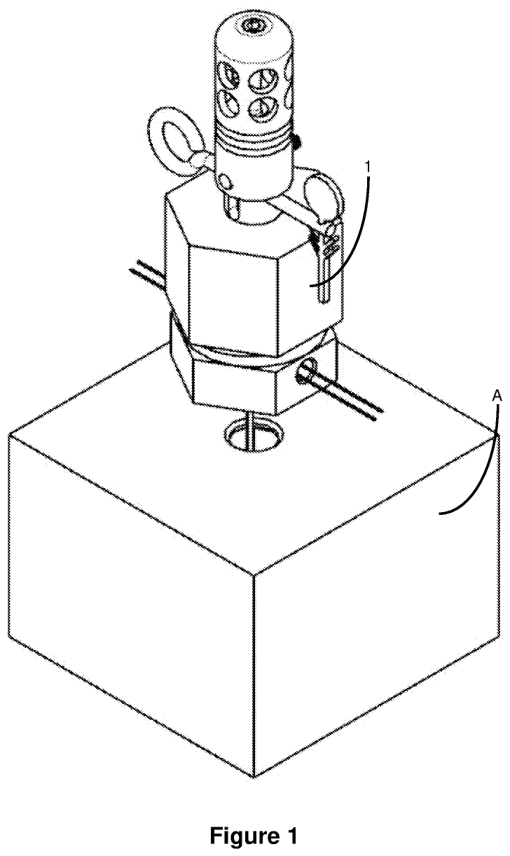

This invention relates a thermo activator (1) that enables any unit, equipment, mechanism, fuse, module, device etc and/or systems to which it is connected to be operated, shut down, controlled, regulated, activated and/or de-activated as desired (stand alone, single, multiple) autonomously and automatically or dependently when the temperature in the environment reaches a desired (predetermined) level (FIG. 1).

The activator (1) can be used for any unit, equipment, mechanism, fuse, module or device etc sensitive to the electrical signal, as well as for any weak or strong current system (fire alarm, fire extinguishing, ventilation, heating, cooling, automation, communication, sound, access control, warning, etc. system).

One of the areas where the activator (1) can be widely used is fire detection, fire extinguishing systems and equipment. For ease of explanation and to set an example, the use of the activator (1) in the field of fire detection and extinguishing will be emphasized in this detailed explanation from now on.

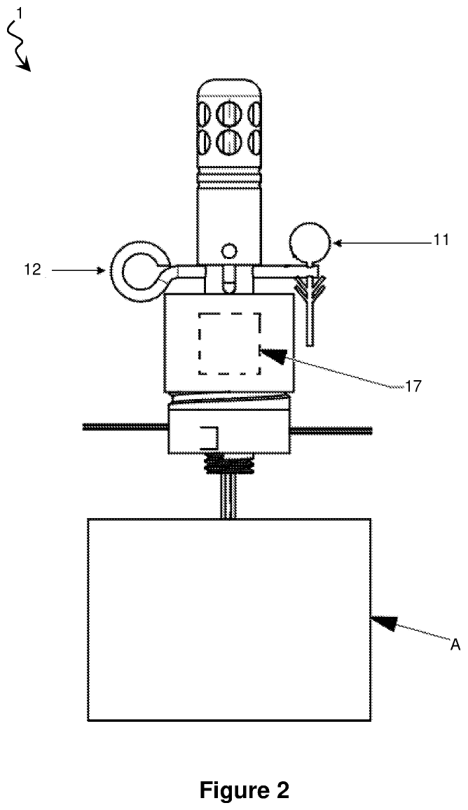

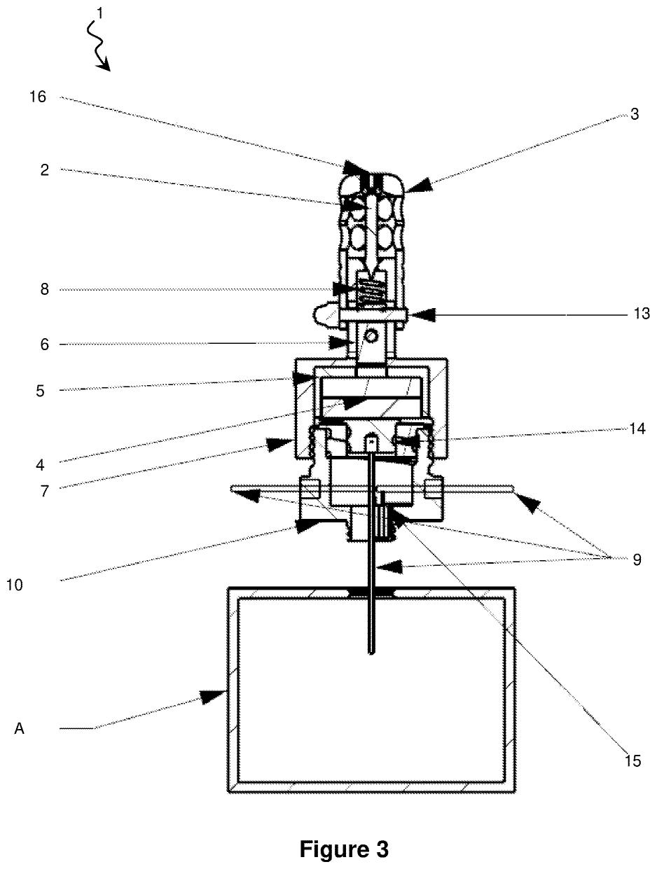

The system (1), which is the subject of the invention, comprises the following (FIG. 2, FIG. 3);
a heat-sensitive part (2), made of a glass tube (thermo bulb, sprinkler bulb) that operates on the principle that the liquid inside expands and bursts with the increase in temperature, or manufactured from any material (for example, metal, plastic, composite, etc.) which deforms and initiates the activation by giving the first reaction when the ambient temperature reaches the desired (predetermined) level,
a cap (3), which protects the heat-sensitive part (2) inside it against external impacts, and enables the ambient heat to reach the heat-sensitive part (2) freely by means of the small holes on it,
a built-in power source (4), such as a battery that converts chemical energy into electrical energy,
a power source slot (5), which protects the built-in power source (4) and prevents short circuits in the built-in power source (4) by means of its insulated structure,
a contact part (6), which allows the safety pin (12) and installation pin (13) to pass through the holes on it, passes through the hole on the power source slot (5), completes the circuit by contacting the built-in power source (4) from the top, and transmitting electricity it receives,
a body (7) that houses and protects the spring (8), contact part (6), installation pin (13) and built-in power source (4) in the power source slot (5),
   allows the heat-sensitive part (2) to be securely attached and not to move after installation by means of its special design on the part that comes into contact with the heat-sensitive part (2) (bearing, a hole with a decreasing diameter until the opening in the middle), that allows free movement of the elements by means of the aperture on it and transmits the electricity taken form the upper part of the built-in power source (4) over itself,
   a spring (8) located inside the body (7), which is compressed in normal condition and is released by deformation of the heat sensitive part (2), and ensures the contact of the conductive contact part (6) underneath with the built-in power source (4) to complete the circuit,
   a signal cable (9) which enables the transmission of signals from the built-in power source (4) and transmitted over the body (7) to one or more signal points (A), which are all kinds of units, equipment, mechanisms, fuses, modules, devices etc and/or systems (weak or strong current system) that are sensitive to the electrical signal and/or the reception of the signals from the signal points (A),
   a cable slot (10) that allows multiplying of number of signal input/output points if desired, that allows transmission of electric signal from the activator (1) to one or more signal points (A), and/or reception of signals from these signal points (A) to the activator (1), that allows installation of the activator (1) at the desired signal point as well as allowing signal cables pass through its connection point (protrusion) by means of its special design (hollow inside, ribbed protrusion outside) and that ensured that any signal cable is not visible from outside when the activator (1) is connected to a single signal point (A),
   a safety pin (12), which is passed through the holes on the body (7) and the contact part (6) that becomes safer by means of the secondary pin (11) engaged at the hole at its tip, that can be installed and removed, that ensures safe operation, that prevents the activator (1) from accidental operation when the heat-sensitive part (2) becomes deformed as a result of any shock during transportation, installation, dismantling or service, that makes the activator (1) ready for use when pulled after the installation of activator (1) at the desired location,
   an installation pin (13) which is passed through the holes on the body (7) and the contact part (6) that preferably has a wide head at one end and a blind nut at the other end mounted at threads, that ensures that the spring (8) is kept in compressed state, that allows attaching of cap (3), contact part (6) and body (7) to each other and that transfers the signal from the contact part (6) to the body (7),
   a signal transmission mechanism (14) that contacts the built-in power source (4) at one side (bottom) and conveys the electric signal it receives to one or more signal cables (9), that is protected by the cable slot (10) and that prevents short circuit by means of its insulated structure, and
   a cable lug (15) that conveys the electric signal which comes to the cable slot (10) from built-in power source (4) through contact part (6) and body (7) to one or more signal cables (9) and that can be installed from outside the body (7) in connections made to a single signal point (A), and
   a set screw (16) placed on the cap (3), which enables the heat-sensitive part (2) to be installed to the activator (1) easily with a certain torque and replaced when necessary.

The inputs and outputs to the cable slot (10) in the activator (1) can be in the form of a direct signal cable (9) connection, or in an easy way, such as a socket or USB input. In an embodiment of the invention, the activator (1) can transmit and receive signals wirelessly, without any signal cable (9) connection, by means of the chip (17) it comprises.

There is a hole on the power source slot (5) for the passage of the contact part (6).

There is a cap (3) on the upper part of the activator (1) to protect the heat sensitive part (2) inside. Heat-sensitive part (2) can be made from a glass tube (sprinkler bulb/thermal bulb) or from any other material (metal, plastic, composite, etc.) that deforms when the desired temperature is reached. Heat-sensitive part (2) is shown as glass tube/sprinkler bulb in figures.

There are holes on the cap (3) that allow the ambient temperature to reach the heat-sensitive part (2) freely. The heat-sensitive part (2), which will deform at the temperature level at which the activator (1) is desired to operate, is placed into the cap (3) with a set screw (16). The set screw (16) is used to tighten the heat sensitive part (2) with a certain torque. If desired, the sensitive part (2) can be placed inside the cap (3) without using the set screw (16). When the ambient temperature reaches the predetermined level for the activator (1) to operate, the heat-sensitive part (2) inside the cap (3) deforms/breaks/bursts. With the deformation of the heat sensitive part (2), the spring (8), which is compressed by means of the installation pin (13), is released and pushes the contact part (6) towards the built-in power source (4). The pushed contact part (6) contacts the built-in power source (4) in the power source slot (5). The electrical signal received from the top of the built-in power source (4) is transmitted wirelessly to the cable slot (10) via the contact part (6), installation pin (13) and body (7). This electrical signal is then transferred to one or more signal cables (9) via cable slot (10) and cable lug (15). Transfer of electrical signal in this way, is one of the distinctive/unique features of the activator (1). The signal transmission mechanism (14), which contacts the built-in power source (4) from the other side, transfers the electrical signal received from this side to one or more signal cables (9).

By means of its insulated structure, the power source slot (5) prevents short-circuiting of the built-in power source (4). The built-in power source (4), power source slot (5), contact part (6) and the spring (8) are protected by the body (7). The electrical signal that emerges due to the contact of the contact part (6), which is moved by the spring (8) that is released by deformation of the heat-sensitive part (2), to the built-in power source (4), is transmitted to one or more than one signal points (A), through signal cables (9) coming out of the cable slot (10). With the electrical signal received from the built-in power source (4), this signal point or points (A) are regulated as desired. These signal points (A) can be activated or deactivated (excluded, turned off, reduced). This signal point or points (A) can be any unit, equipment, mechanism, fuse, module, device etc or any system (fire alarm, fire extinguishing, automation, communication, public address, access control, warning and any other weak current system and/or strong current system). The cable slot (10) allows the signal cables (9) to enter/exit and, if desired, allows the number of electrical signal input/output points to be multiplied. There may be one exit from the cable slot (10) for Signal cables (9) going to one single signal point (A) or more than one exits going to multiple signal points (A) (FIG. 3). Depending on the number of exits (inputs/outputs) of the signal cable (9) in the cable slot (10), the activator (1) becomes a single (fully autonomous) or multiple (multifunctional/communicating with more than one point, interactive) device.

There is a safety pin (12) on the activator (1) to ensure its safe use. Safety pin (12) prevents the activator (1) from accidental operation when the heat-sensitive part (2) becomes deformed as a result of any shock during transportation, installation, dismantling or service. After the activator (1) is installed safely to the desired location, the safety pin (12) is pulled and the activator (1) is made ready for use.

By using the electrical signal received from the built-in power source (4), triggered by the heat-sensitive part (2), the activator of the invention (1) enables the places where it is connected to be controlled/regulated/activated/de-activated, in a fully autonomous and automatic manner or dependently within a system, as desired.

By means of the activator (1) of the invention, all kinds of units, equipment, mechanisms, fuses, modules, devices etc. and/or systems sensitive to the electrical signal (weak or strong current systems) can be controlled/regulated/activated/de-activated as desired (stand alone, single, multiple, autonomous or dependent) when the ambient temperature reaches the desired (predetermined) level.

Human intervention is not required for the activator (1) to operate (as in manual activation). However, it can also be used as a manual activator (1) if desired. Pulling out the safety pin (12) in the absence of heat-sensitive part (2) provides manual activation.

The activator (1) is triggered by thermal effect and does the desired activation by using the electrical signal inside.

The activator (1) solves the problem of thermal and thermoelectric activators in the present technique not being integrated with any system. The activator (1) solves this problem by transmitting the electrical signal it receives from its built-in power source (4) to one or more systems to which it is connected.

The activator (1) solves the problem of thermal and thermoelectric activators in the present technique not being operable with an external signal. The activator (1) solves this problem by means of its ability of integration into the engineering networks in its environment. Thus, the activator (1) can do the activation with an external signal also.

The activator (1) solves the problem that thermal activators in the present technique cannot activate more than one point (unit, equipment, module, device etc.) and thermoelectric activators cannot activate more than two signal points (A) at the same time. The activator (1) solves this problem by working with an electrical signal and, when necessary, generating this signal within its own body and transmitting it to more than two signal points (A) at the same time.

The activator (1) solves the problem of only autonomous and automatic activation of thermal and thermoelectric activators in the present technique. The activator (1) does this by means of its ability to integrate into the engineering networks in its environment. Thus, it can provide activation with an external signal too.

The activator (1) solves the problem in the present technique that autonomous and automatic activation by thermal effect can be used only in small spaces. By means of the activator (1), autonomous and automatic activation can be used in any small or large space. The activator (1) does this by means of its detection with the heat-sensitive part (2) on it, and its ability to send the electrical signal it receives from the built-in power source (4) to more than one signal points (A).

The activator (1) comprises both, the heat-sensitive part (2) required by a thermal activator and the electrical energy required for the operation of an electric activator, internally (built-in) at the same time. The activator (1) has features of both thermal and thermoelectric activators and also has a built-in power source (4) on it.

The activator (1) can be used only as a thermal activator if desired, as an electric activator if desired, and as a thermal and electric activator at the same time, if desired.

The activator (1) can be connected to a single signal point (A) if desired. When the ambient temperature reaches the predetermined level, the activator (1) automatically activates the signal point (A) to which it is connected.

The activator (1) can form a group by connecting to more than one signal point (A) at the same time, if desired. For example, more than one fire extinguishing equipment (aerosol generator, pressurized tube, etc.) can be connected in a group to a single activator (1). When the ambient temperature reaches the predetermined level, the activator (1) autonomously and automatically activates this multiple group to which it is connected at the same time.

The activator (1) solves the problem of small (low capacity) Aerosol Generators not being used in large spaces, because it allows grouping.

The activator (1) solves the problem of the inability of electrical activators in the present technique to operate autonomously. The activator (1) does this by means of the ability to have the heat-sensitive part (2) and the built-in power source (4) on it at the same time.

The activator (1) solves the problem that electrical activators in the present technique cannot work without an installed system (fire alarm, fire extinguishing). The activator (1) does this by means of its ability to detect with the heat-sensitive part (2) on it and to receive energy from its own built-in power source (4). There is no need to install a separate system in the place where the activator (1) is used. Therefore, the activator (1) offers a practical and inexpensive solution. The activator (1) significantly reduces the initial investment and periodic maintenance costs.

The activator (1) solves the problem of electrical activation not being feasible for small spaces. By means of the activator (1), electrical activation in any small/large space can be performed at a low cost.

Even though the activator (1) does not need any connection to an external system for its own operation, it can be easily integrated into these systems if there are any system (fire alarm, fire extinguishing, ventilation, heating, cooling, automation, communication, voiceover, etc.) in the space where it is used and if it is desired so. The activator (1) can control, regulate, activate, de-activate these systems itself, or control/activation can be provided through the activator (1) with a signal from these systems.

By means of the activator (1), it will be possible to use many units, equipment, mechanisms, fuses, modules, devices etc. or systems (e.g. aerosol fire extinguishing system) that are required to operate when the ambient temperature rises above a certain level, more widely, more cheaply and more practically.

The activator (1) does not require an external power supply to operate.

The activator (1) receives the energy required to operate from the built-in power source (4) on it. By means of this feature, the activator (1) can be used safely even where there is no electricity, offering a practical and very inexpensive solution.

Since the activator (1) is not connected to the electrical panel and network system, our invention is not affected by power outages/surges that may occur due to natural disasters (earthquake, flood, lightning, bad weather conditions, etc.).

If desired, the activation feature of the activator (1) may not be used. The activator (1) can also be used just like a thermal detector.

The activator (1) can activate and send signals to its connected locations if its heat-sensitive part (2) is a glass bulb, at 6 different temperature levels (57° C., 68° C., 79° C., 93° C., 141° C., 182° C., which are the standard glass bulb working temperatures on the market).

The activator (1) has a long service life and is suitable for harsh environmental conditions (such as low or high temperature environment, high humidity environment). The activator (1) can be easily placed on moving objects (e.g. motor vehicles).

In the activator (1), the heat-sensitive part (2) does not have to be made of a glass tube (sprinkler bulb/thermal bulb). Heat-sensitive part (2) can be made of any material (metal, plastic, composite, etc.) that deforms when the desired temperature is reached.

The activator (1) is durable and highly secure. All important parts of the activator (1) (e.g. heat-sensitive part (2) and built-in power supply (4)) are protected within the cap (3) and body (7) against external influences (impacts).

The activator (1) provides high safety thanks to the safety pin (12) on it. The safety pin (12) becomes safer by means of the secondary pin (11) inserted into the hole at the end. Safety pin (12) prevents accidental operation of the activator (1) when the heat-sensitive part (2) becomes deformed as a result of any shock during transportation, installation, dismantling or service. After the safe installation of the activator (1) at the desired location, the safety pin (12) is pulled out and the activator (1) is made ready for use. Safety pin (12) and secondary pin (11) are detachable and pluggable.

By means of its special design, the activator (1) transmits the electrical signal received from one side (top) of the built-in power source (4), through its own parts and body (7) to the cable lug (15) at the output point of signal cable (9) without using cables. This feature is one of the distinguishing features of the activator (1). If desired, this signal can also be transmitted by a conductor such as a cable

The activator (1) is designed to allow the built-in power source (4) to be easily installed/replaced by persons who are not experts on the subject. In this way, the activator (1) can be used for many years by only replacing the built-in power source (4).

The activator (1) can be reused by renewing/replacing only the heat-sensitive part (2) and/or built-in power source (4), if necessary.

1. A thermo activator that enables a unit, equipment, mechanism, fuse, module, device etc. and/or systems to which the said thermo activator is connected to be operated, shut down, controlled, regulated, activated and/or deactivated as desired (stand alone, single, multiple) autonomously and automatically or dependently when the ambient temperature reaches a desired level, the thermo activator comprising:
a heat-sensitive part which is made of a glass tube/bulb (thermo bulb, sprinkler bulb) that operates on the principle that liquid inside expands and bursts with an increase in temperature, or manufactured from any material that deforms and initiates the activation by giving the first reaction when the ambient temperature reaches the desired level;
a cap, which protects the heat-sensitive part inside the said cap against external impacts, and enables the ambient heat to reach the heat sensitive part freely by means of the small holes on the said cap;
a built-in power source, such as a battery that converts chemical energy into electrical energy;
a power source slot, which protects the built-in power source and prevents short circuits in the built-in power source by means of its insulated structure;
a contact part, which allows a safety pin and installation pin to pass through the holes on it, passes through the hole on the power source slot, completes the circuit by contacting the built-in power source from the top, and transmitting electricity the said contact part-receives;
a body that houses and protects a spring, contact part, installation pin and built-in power source in the power source slot, that allows the heat-sensitive part to be securely attached and not to move after installation by means of its special design on the part that comes into contact with the heat-sensitive part (bearing, a hole with a decreasing diameter until the opening in the middle), that allows free movement of the elements by means of the aperture on the said and transmits the electricity taken form the upper part of the built-in power source over itself;
a wherein the spring is located inside the body, which is compressed in normal condition and is released by the deformation of the heat sensitive part and ensures the contact of the conductive contact part-underneath with the built-in power source to complete the circuit;
a signal cable which enables the transmission of signals from the built-in power source and transmitted over the body to one or more signal points, which are all kinds of units, equipment, mechanisms, fuses, modules, devices etc. and/or systems (weak or strong current system) that are sensitive to the electrical signal and I or the reception of the signals from the signal points;
a cable slot that allows multiplying of number of signal input/output points if desired, that allows transmission of electric signal from the activator to one or more signal points, and/or reception of signals from these signal points to the activator, that allows installation of the activator at the desired signal point as well as allowing signal cables pass through its connection point by means of its special design (hollow inside, ribbed protrusion outside) and that ensures that any signal cable is not visible from outside when the activator is connected to a single signal point;
wherein the safety pin is passed through the holes on the body and the contact part that becomes safer by means of the secondary pin engaged at the hole at its tip, that can be installed and removed, that ensures safe operation, that prevents the activator from accidental operation when the heat-sensitive part becomes deformed as a result of any shock during transportation, installation, dismantling or service, that makes the activator ready for use when pulled after the installation of activator at the desired location;
wherein the installation pin is passed through the holes on the body and the contact part that preferably has a wide head at one end and a blind nut at the other end mounted at threads, that ensures that the spring is kept in compressed state, that allows attaching of the cap, contact part and body to each other and that transfers the signal from the contact part to the body;
a signal transmission mechanism that contacts the built-in power source at one side and conveys the electric signal the said signal transmission mechanism receives to one or more signal cables, that is protected by the cable slot and that prevents short circuit by means of its insulated structure;
a cable lug that conveys the electric signal which comes to the cable slot from built-in power source through contact part and body to one or more signal cables and that can be installed from outside the body in connections made to a single signal point; and
a set screw placed on the cap, which enables the heat-sensitive part to be attached to the activator easily with a certain torque and replaced when necessary.

2. The thermo activator according to claim 1, the thermo activator comprising a chip that allows transmission and reception of the signals wirelessly without any signal cable connection.

3. The thermo activator according to claim 1, wherein the contact part, installation pin and body allows transmission of the electric signal from the upper part of the built-in power source to the cable slot wirelessly.
